(19) United States
(12) Patent Application Publication
(10) Pub. No.: US 2010/0128483 A1
(43) Pub. Date: May 27, 2010

(54) LED LUMINAIRE

(75) Inventors: Ann Marie Reo, Wilmette, IL (US); Chantal Louise Moore, Austin, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/277,834

(22) Filed: Nov. 25, 2008

(51) Int. Cl. F21V 29/02; F21V 21/00

(52) U.S. Cl. 362/294; 362/249.02; 362/235; 362/373

(57) ABSTRACT

A luminaire described herein reduces energy consumption without limiting the light output and beam spreads. This configuration is useful for retail applications where a dimmable point source illumination is beneficial and minimal degradation due to damaging UV, IR, and heat may be important to product shelf life. The luminaire combines a light source, a thermal management system, a printed circuit board, and optics and shielding components in a single unit to accomplish these objectives. The substantially cylindrical lighting assembly includes a plurality of LEDs configured to emit light from a front end; a thermal management system for cooling the LEDs from a back end; a printed circuit board electrically coupled to the LEDs and the thermal management system; a refractor positioned adjacent the LEDs on the front end; and a shielding component positioned along the front end of the lighting assembly.

### TECHNICAL FIELD

This invention relates generally to a configuration for a luminaire using LEDs.

### BACKGROUND

Light emitting diodes (LEDs) offer benefits over incandescent and fluorescent lights as sources of illumination. Such benefits include high energy efficiency and longevity. To produce a given output of light, an LED consumes less electricity than an incandescent or a fluorescent light. And, on average, the LED will last longer before failing.

The level of light a typical LED outputs depends upon the amount of electrical current supplied to the LED and upon the operating temperature of the LED. That is, the intensity of light emitted by an LED changes according to electrical current and LED temperature. Operating temperature also impacts the usable lifetime of most LEDs.

As a byproduct of converting electricity into light, LEDs generate heat that can raise the operating temperature if allowed to accumulate, resulting in efficiency degradation and premature failure. The conventional technologies available for handling and removing this heat are generally limited in terms of performance and integration. For example, most heat management systems are separated from the optical systems that handle the light output by the LEDs. The lack of integration often fails to provide a desirable level of compactness or to support efficient luminaire manufacturing.

A conventional lighting system utilizes Par 38 LED, incandescent, or high intensity discharge (e.g., metal halide) based replacements lamps with a medium Edison screw base. However, the conventional lighting systems do not deliver the efficacy, field changeable beam spreads, and shielding as part of the LED lamp module itself. The conventional lighting systems are beam spread specific (like conventional Par 38 incandescent light sources) and depend on the luminaire for shielding devices.

Accordingly, to address these representative deficiencies in the art, an improved technology for managing the heat and light LEDs produce is needed. A need also exists for an integrated system that can manage heat and light in an LED-based luminaire. An additional need exists for a compact lighting system having a design supporting low-cost manufacture. A capability addressing one or more of the aforementioned needs (or some similar lacking in the field) would advance LED lighting. It is also desirable to reduce energy consumption while producing the same light output and beam spreads.

### SUMMARY

Exemplary embodiments described herein attempt to reduce energy consumption without limiting the light output and beam spreads. The exemplary embodiments may be useful for retail applications where a dimmable point source illumination is beneficial and minimal degradation due to damaging ultraviolet, infrared, and heat may be important to product shelf life. The packaging of a luminaire can include optic and shielding components, a printed circuit board, thermal management, and an electrical feed for connecting the luminaire as a monopoint or track lighting fixture. The electrical feed to a line voltage or a low voltage track can allow for electrical management of LEDs to provide for an appropriate constant current of the LEDs, which can also be pulse width modulated for dimming the LEDs and lowering the electrical voltage and power required for a cooling device.

In one aspect, a luminaire housing has a light source array positioned at a first end of the luminaire housing; a cooling device for cooling the light source array, the cooling device positioned at a second end of the housing; a heat sink region disposed between the light source array and the cooling device, wherein the cooling device is configured to direct air away from the heat sink region; and a shielding device substantially surrounding the light source along an edge of the first end of the luminaire.

In another aspect, a substantially cylindrical lighting assembly has a front end and a back end. The lighting assembly also has a plurality of light emitting diodes configured to emit light from the front end; a thermal management system for cooling the light emitting diodes from the back end; a printed circuit board connected to the light emitting diodes and the thermal management system; a refractor positioned on the light emitting diodes on the front end; and a shielding component positioned on the front end of the lighting assembly.

These and other aspects, objects, and features of the invention will become apparent to those having ordinary skill in the art upon consideration of the following detailed description of exemplary embodiments exemplifying the best mode for carrying out the invention as presently perceived.

### BRIEF DESCRIPTION OF THE DRAWINGS

FIG. 1a shows a perspective view of a luminaire according to an exemplary embodiment.

FIG. 1b shows a rear view of a luminaire according to an exemplary embodiment.

FIG. 1c shows a side view of a luminaire according to an exemplary embodiment.

FIG. 1d shows a frontal view of a luminaire according to an exemplary embodiment.

FIG. 2 shows a luminaire mounted to a track according to an exemplary embodiment.

FIG. 3 shows a mounted luminaire according to an exemplary embodiment.

FIG. 4 shows a cross-sectional view of a mounted luminaire according to an exemplary embodiment.

### DETAILED DESCRIPTION

The invention may be better understood by reading the following description of non-limitative, exemplary embodiments with reference to the attached drawings wherein like parts of each of the figures are identified by the same reference characters.

The term “luminaire,” as used herein, generally refers to a system for producing, controlling, and/or distributing light for illumination. A luminaire can be a system outputting or distributing light into an environment so that people can observe items in the environment. Such a system could be a complete lighting unit comprising one or more LEDs for converting electrical energy into light; sockets, connectors, or receptacles for mechanically mounting and/or electrically connecting components to the system; optical elements for distributing light; and mechanical components for supporting or attaching the luminaire. Luminaires are sometimes referred to as “lighting fixtures” or as “light fixtures.” A lighting fixture that has a socket for a light source, but no light source installed in the socket, can still be considered a luminaire. That is, a lighting system lacking some provision for full operability may still fit the definition of a luminaire.

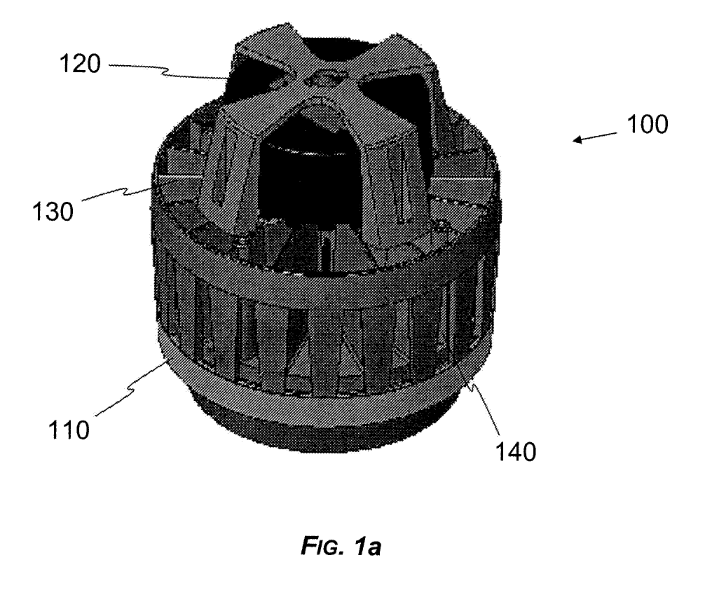

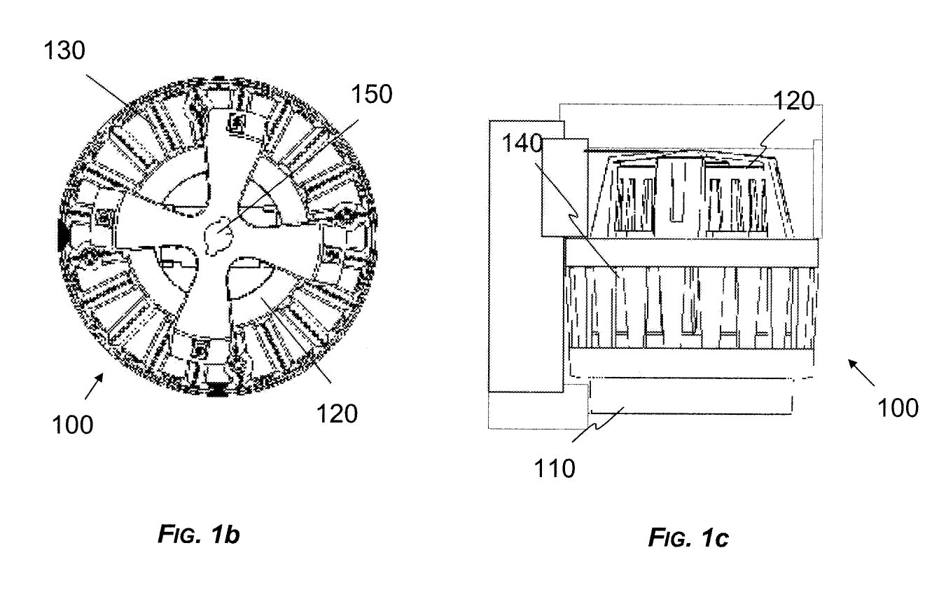

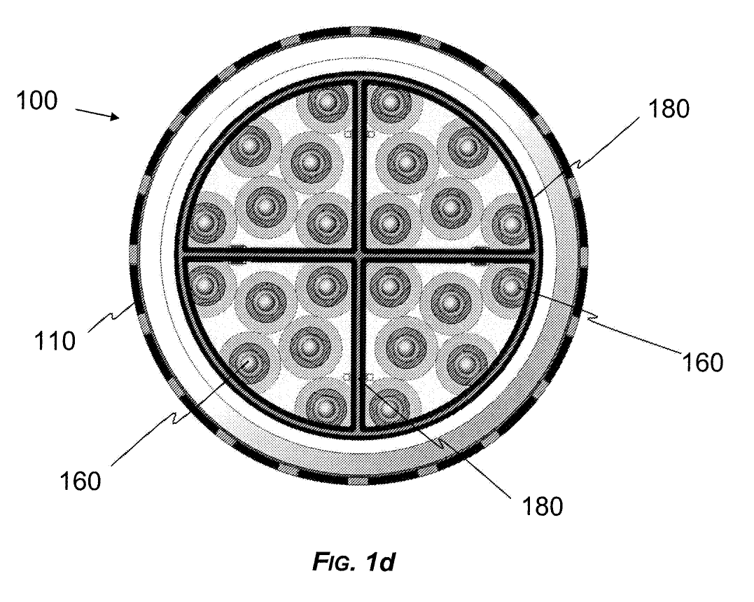

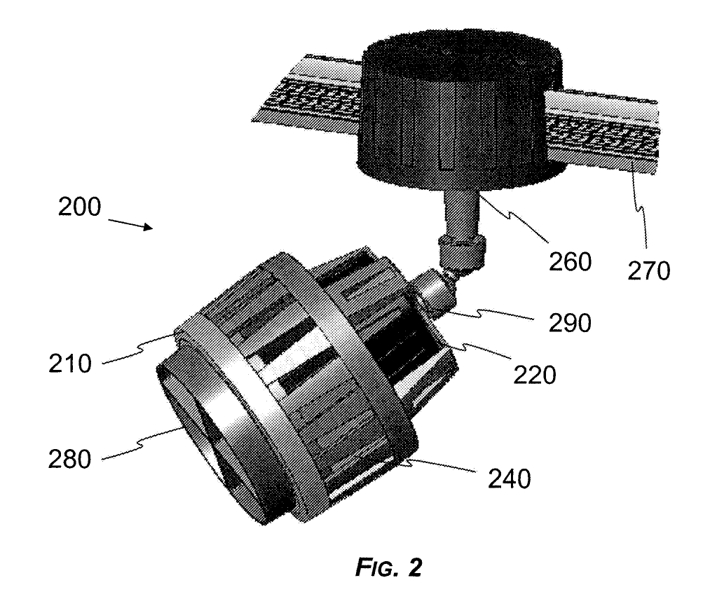

Referring to FIGS. 1a to 1c, an exemplary luminaire 100 is shown. Luminaire 100 combines a printed circuit board, optic and shielding devices, and thermal management in a single unit. The outer diameter of the luminaire 100 can be approximately the same as a conventional Par 38 light source. As a result, luminaire 100 can be used in retrofitting applications, such as where track lighting is used.

Luminaire 100 has a front trim bezel 110. Optionally, bezel 110 can be removable to allow a user to change the optics or shielding devices in luminaire 100. The bezel 110 can be attached to the luminaire 100 using a hinge or screwing means.

The optics can be configured to target a lumen output. For example, a plurality of LEDs, e.g., 24 LEDs, can be arranged in an array to provide a particular output, such as 900 lumens, 1200 lumens, or 1800 lumens. Some desired outputs may require more thermal management than other outputs.

A refractor (not shown) may be used in front of the LEDs to blend the luminous intensity so that the luminaire does not emit light that appears as a plurality of bright points. The refractor can have collimators for each of the LEDs. For example, if there are 24 LEDs, then 24 collimators can be imbedded in the refractor. The refractor collimator can be injection molded as a single piece. As a result, a user can change a single lens, rather than a refractor and individual collimators.

Referring to FIG. 1d, a frontal view of an array of LEDs 160 in luminaire 100 is shown. In this exemplary embodiment, luminaire 100 has an optical component comprising 24 LEDs 160. The LEDs are coupled to a printed circuit board (PCB) (shown in FIG. 4). The PCB is a circular array of individual LEDs 160 arranged in three concentric circles. In this particular example, 1 watt LEDs can be used, but it is intended that any type of LED can be used. Additionally, the LEDs can be MR-16 compatible or can be configured according to another standard. Bezel 110 can be removed to access the array of LEDs 160. A shielding component 180 is positioned in front of the LEDs 160. The shielding component 180 can be a cross blade baffle, a snoot, or any other shielding configuration. In this exemplary embodiment, shielding component 180 is a cross blade baffle that divides the optical component into four quadrants. Each quadrant is symmetric and has six LEDs 160.

The optical component can be formed as a single injection molded component having a plurality of individual refractors embedded in the component. Each individual refractor can encompass an LED 160. Each refractor can envelop and control the corresponding LED.

The ability to configure the optical components also allows various beam spreads based on the distribution of the LEDs in the luminaire. For example, the luminaire can provide various beam spreads, including, but not limited to, a 10 degree, 25 degree, or 50 degree beam spread. Because a user can change the optics and shielding components, such as the refractor and the LED configuration (which may include the number and spacing of LEDs), the user can change the beam spread as well. In one example, the user may adjust the beam spread to a narrower beam, e.g., 10 degrees, as may be desired in a retail application. The beam spreads are adjusted by field changing the removable optic component and replacing it with another optic component. Each beam angle has it's own optic component, which can be custom molded to give specifically desired beam angles.

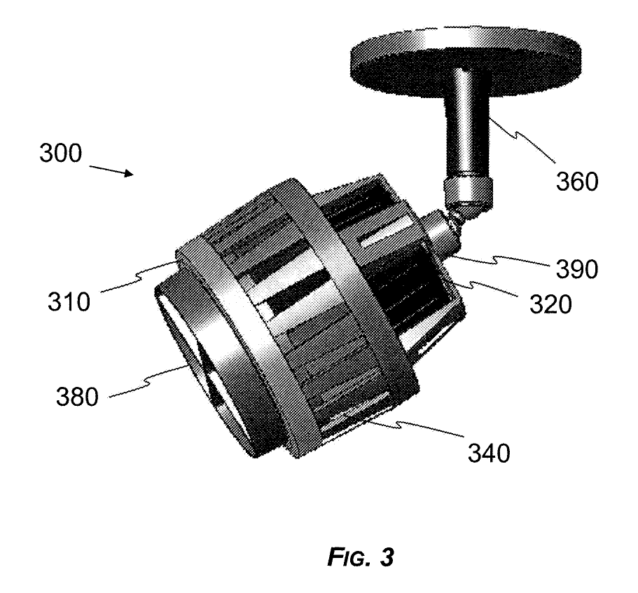

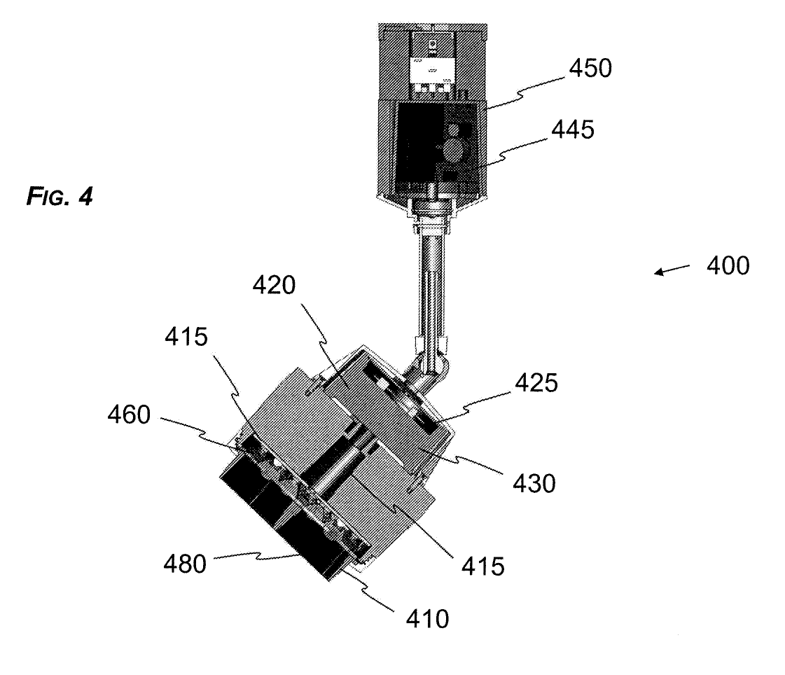

Luminaire 100 has a shielding, shown as a cross-blade baffle 280, 380 in FIGS. 2 and 3 below. Although a cross-blade baffle is shown in the exemplary embodiment, it is not intended to be limited to that configuration and may take the form of a snoot or other shielding configuration. The shielding can be used to block a viewer's direct view of the lens. The shielding has a matte surface and attempts to limit glare from the light produced by the luminaire 100.

Luminaire 100 has an active cooling device 120 for thermal management. Luminaire 100 also has a plurality of radial fins 130 extending from a central axis to an outer perimeter of the luminaire 100. In order to direct air away from the heat sink, the cooling device 120 circulates air around the heat sink fins 130 in a turbulent manner that increases the efficacy of the heat sink itself by moving the boundary layer air proximate to the fins 130. The cooling device 120 produces pulses of air that are emitted from a series of jet nozzles that are positioned optimally with regard to the fins 130. The air passes through the fins 130 and through a plurality of openings 140 along the perimeter of the luminaire. The housing of the luminaire 100, including the bezel 110 and the fins 130 can be constructed from a thermally-conductive, rigid material such as a metal, e.g., aluminum. At lower outputs or currents, the luminaire may be used without the active cooling device and may use passive convective cooling. For higher outputs or currents, an active cooling device may be desirable for achieving the desired lamp life.

The luminaire 100 can be configured to replicate the light output of standard incandescent, metal halide, or halogen lamps, at generally the same or lower power, but with a greater lamp life. The exemplary configuration replicates a 90 W Par 38 incandescent lamp at a certain electrical configuration, which delivers the same or more candela at approximately half the power consumption and more than ten times the life expectancy. Due to the stringent energy codes in certain regions, this reduction in power density through the use of the luminaire 100 makes it a more cost effective and, at times, regulatory compliant solution for businesses and retailers. In another electrical configuration, the luminaire can replicate a 35 W Par 30 CMH lamp, thereby delivering the same or more candela at approximately the same power and with five times the life expectancy.

The form factor of this luminaire configuration allows it to reside in a variety of track heads as well as monopoint or multiple applications. In one exemplary embodiment, the outside diameter of the luminaire matches a conventional Par 38 light source. As a result, the luminaire can be used in many track lighting applications that require a Par 38 lamp. Although the luminaire is described and illustrated as a cylindrical device in the exemplary embodiments, it is understood that this shape is merely an example and is not intended to be limited to this shape.

Referring to FIG. 2, a luminaire 200 can be slidably mounted or clamped on a track 270. Luminaire 200 has a cooling device 220 that, at a certain level of output or current, pulls heat away from the metal core board of a driver (not shown) positioned at the center of the heat sink and directs the air through a plurality of radial fins and out openings along the perimeter of the luminaire 200. A bezel 210 can be removed to access and change any optical components. Luminaire 200 can also have a shielding 280. In one exemplary embodiment, the luminaire 200 has a quick-disconnect electrical feed that attaches to a track-mounted transformer 260 positioned on track 270. The luminaire 200 has a feed 290 that can extend from the center-rear, shown as an aperture 150 in FIG. 1b. The feed 290 has wires that connect to a metal point or track-mounted transformer 260 and electrically coupled with a twist-and-lock or other mating apparatus.

Referring to FIG. 3, a luminaire 300 can be mounted as an adjustable monopoint, pendant, or surface-mounted downlight with a base 360 that can attach to a ceiling, shelf, or other surface. Luminaire 300 has a cooling device 320 that, at a certain level of output or current, pulls heat away from the metal core board of a driver (not shown) positioned at the center of the heat sink and directs the air through a plurality of radial fins and out openings along the perimeter of the luminaire 300. A bezel 310 can be removed to access and change any optical components. Luminaire 300 can also have a shielding 380. The luminaire 300 can have a quick-disconnect electrical feed 390 that can attach to the monopoint base 360.

Referring to FIG. 4, a cross-section of a mounted luminaire 400 is shown. An optional cooling device 420 and a cooling device control circuit 425, such as cooling devices and circuits provided by Nuventix, can pull heat away from a heat sink 430. In lower power or current conditions, the luminaire 400 can use passive cooling, as active cooling by a cooling device is not required. The heat sink 430 has a hollow center 435 to allow for wiring through the heat sink 430 to the optical component. A system control circuit 445 can be positioned in a track adapter 450 and control the power for the luminaire 400 (AC to DC) as well as control the dimming for a PCB 415 and cooling device 420. A driver can be located remotely from the heat sink, such as in a track adapter for track head installations or in a junction box for monopoint installations.

As shown above in FIG. 1d, a plurality of LEDs 460 are coupled to PCB 415. A bezel 410 is removably fixed to the luminaire 400, but can be removed to access a cross blade baffle 480, or other shielding component.

The exemplary embodiments described herein provide for an LED luminaire with a longer lamp life than a conventional incandescent lamp. Additionally, the exemplary embodiment does not include ultraviolet, infrared, or heat radiating from the beam of light. Furthermore, these embodiments reduce energy consumption while producing the same light output and beam spreads as conventional 90 Watt Par 38 lamps. These LED luminaire described herein can be useful in applications such as art and museum lighting, or other high end retail lighting where ultraviolet light can deteriorate the product that is being illuminated.

Therefore, the invention is well adapted to attain the ends and advantages mentioned as well as those that are inherent therein. The particular embodiments disclosed above are illustrative only, as the invention may be modified and practiced in different but equivalent manners apparent to those having ordinary skill in the art and having the benefit of the teachings herein. While numerous changes may be made by those having ordinary skill in the art, such changes are encompassed within the spirit and scope of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A luminaire housing comprising:
a light source array positioned at a first end of the luminaire housing;
a cooling device for cooling the light source array, the cooling device positioned at a second end of the housing;
a heat sink region disposed between the light source array and the cooling device, wherein the cooling device is configured to direct air away from the heat sink region; and
a shielding device substantially surrounding the light source along an edge of the first end of the luminaire.

2. The luminaire according to claim 1, wherein the light source comprises an array of LEDs.

3. The luminaire according to claim 1, wherein when the cooling device is activated, the device directs air towards the light source.

4. The luminaire according to claim 1, wherein the cooling device is activated when the light source array operates at a predetermined level of current.

5. The luminaire according to claim 1, further comprising a plurality of fins extending radially from a central axis, wherein an air stream flows between the fins.

6. The luminaire according to claim 5, wherein the cooling device supplements an amount of air in the air stream flowing between the fins

7. The luminaire according to claim 5, further comprising a plurality of apertures disposed along a perimeter of the luminaire, wherein at least a portion of the air generated by the cooling device exits the luminaire through the apertures.

8. The luminaire according to claim 1, wherein the shielding device is a cross-blade baffle.

9. The luminaire according to claim 1, wherein the shielding device is a snoot.

10. The luminaire according to claim 1, further comprising an electrical feed extending from a rear of the luminaire configured to be connected to a electrical supply at a mounting location.

11. The luminaire according to claim 2, further comprising a refractor positioned on the light-emitting side of the array of LEDs and comprising a collimator for each LED in the array of LEDs.

12. The luminaire according to claim 1, further comprising a bezel positioned adjacent the light source.

13. The luminaire according to claim 1, further comprising an aperture in the heat sink between the cooling device and the light source.

14. The luminaire according to claim 2, wherein each LED is coupled to a printed circuit board.

15. The luminaire according to claim 13, wherein each LED has a refractor.

16. A substantially cylindrical lighting assembly having a front end and a back end, the lighting assembly comprising:
a plurality of light emitting diodes configured to emit light from the front end;
a thermal management system for cooling the light emitting diodes from the back end;
a printed circuit board electrically coupled to the light emitting diodes, the thermal management system, and a control circuit; and
a refractor positioned adjacent the light emitting diodes along the front end.

17. The lighting assembly according to claim 16, further comprising a shielding component positioned on the front end of the lighting assembly.

18. The lighting assembly according to claim 16, wherein the thermal management system comprises a plurality of fins extending from a central axis to a perimeter of the lighting assembly, and a plurality of openings along the perimeter of the lighting assembly, wherein a cooling device positioned on the back end of the lighting assembly directs air toward the front end of the lighting assembly through the fins and out of the openings.

19. The lighting assembly according to claim 17, wherein the shielding component is a cross-blade baffle.

20. The lighting assembly according to claim 17, wherein the shielding component is a snoot.

21. The lighting assembly according to claim 16, further comprising an electrical feed extending from the back end of the lighting assembly and electrically coupled to the control circuit, wherein the electrical feed is configured to be connected to an electrical supply of a track-mounted transformer or a monopoint base.

22. The lighting assembly according to claim 17, further comprising a bezel positioned between the refractor and the shielding component.
